(19) United States
(12) Patent Application Publication
(10) Pub. No.: US 2019/0225360 A1
(43) Pub. Date: Jul. 25, 2019

(54) APPARATUS FOR PROCESSING CONTAINERS

(71) Applicant: SACMI IMOLA S.C., Imola (IT)

(72) Inventors: Maurizio PEDERCINI, Marmirolo (IT); Daniele MAZZUCCO, Marmirolo (IT); Mirco MASSARI, Parma (IT); Lorenzo CASADIO, Lugo (IT)

(73) Assignee: SACMI IMOLA S.C., Imola (IT)

(21) Appl. No.: 15/743,076

(22) PCT Filed: Jul. 5, 2016
(86) PCT No.: PCT/EP2016/065855

§ 371 Date: Jan. 9, 2018

(30) Foreign Application Priority Data
Jul. 10, 2015 (IT) 102015000032730

(51) Int. Cl. B65C 9/40; B65C 1/02

(52) U.S. Cl. CPC B65C 9/40; B65C 1/02

(57) ABSTRACT

An apparatus for processing containers includes at least one processing assembly for containers and elements for feeding, with a continuous flow, the containers to a labeling unit having at least one labeling station intended to label the containers that arrive from a respective flow of containers. The apparatus includes elements for identifying non-conforming containers configured to be ejected from the respective flow of containers, expulsion elements configured to remove, from the respective flow intended for a respective labeling station, the containers that immediately follow the positions of the non-conforming containers along the advancement direction of the flow in order to obtain, in the respective flow, an uninterrupted sequence of missing containers in a number equal to at least one preset number.

### TECHNICAL FIELD

The present disclosure relates to an apparatus for processing containers.

### BACKGROUND

Apparatuses are known for processing containers which comprise one or more processing assemblies which are constituted, for example, by an assembly for blowing the preforms, a labeling assembly, a filling assembly, etc.

In some cases the apparatuses have a single processing assembly, while in other cases there can be two or more processing assemblies in sequence.

In particular, some types of apparatuses have a blower and, in succession, a labeling unit, or a filling machine and, between the blower and the processing assembly arranged immediately downstream therefrom, means for transferring the containers with a continuous flow.

Very often, along the transfer means, the flow of containers is not continuous but contains “holes” or missing containers owing to the discarding of non-conforming containers.

Especially if there is a continuous flow of containers between the blower and the labeling unit, it is important that there be means of checking and detecting any “holes” in the flow of containers, which are associated with a device for controlling the labeling unit in order to prevent it from dispensing the label when the container is missing.

Very often situations can arise in which the holes appear at intervals with a very small number of containers between them.

In this case, it can be a problem to cater for sequences of interruption of the labeling process which occur very close together, while keeping the speed of feeding containers unaltered.

In order to resolve such problem, EP2295326B1 discloses a labeling unit, optionally but not necessarily usable in a three-block structure, provided with a blower upstream and with a filling machine/cap applicator downstream.

The general problem that the disclosure in EP2295326B1 sets out to solve is that of managing the labeling unit in cases where bottles are missing in the arriving continuous flow.

Specifically, the solution described in the above mentioned patent deals with the problem that arises if “gaps” or “holes” are found in a continuous flow, with just a few containers between them.

As previously mentioned in fact, in this case the labeling unit could not be stopped and made to resume in time to label the few bottles that are interposed between two consecutive gaps.

The solution disclosed in EP2295326B1 consists of using the device for detecting the containers to be labeled (which is known per se) to stop the labeling if a predetermined incoming flow of containers and gaps is detected, so as to not label the containers comprised between two points without containers.

In essence, the machine does not apply labels to the containers between contiguous gaps, stopping the labeling for the time necessary to allow this flow of isolated containers to pass through the labeling unit.

The devised solution, although it reduces the intermittent actuation of the labeling unit in some cases, is not devoid of drawbacks.

In fact, firstly it should be noted that the unlabeled containers that are between two closely-occurring gaps must still be managed and somehow discarded.

Usually this occurs after the filling machine and therefore what happens is that, in addition to the container being discarded, the cap and the liquid are discarded as well.

Furthermore, the solution taught does not make it possible to optimally manage any stoppages of the labeling unit if the gaps detected are isolated and not closely-occurring or contiguous.

### SUMMARY

The aim of the present disclosure is to solve the above mentioned problems and overcome the drawbacks, by providing an apparatus for processing containers that is considerably easier and more practical to use.

Within this aim, the disclosure provides an apparatus for processing containers that is extremely simple in terms of construction and is capable of enabling an optimal management of the labeling process by minimizing discards.

These advantages and features which will become better apparent hereinafter are achieved by providing an apparatus for processing containers having at least one processing assembly for containers and means for feeding, with a continuous flow, said containers to a labeling unit comprising at least one labeling station configured to label the containers that arrive from a respective flow of containers, further comprising identification means for identifying non-conforming containers configured to be ejected from the respective flow of containers. The apparatus further includes expulsion means configured to remove, from the respective flow intended for a respective labeling station, the containers that immediately follow the positions of the non-conforming containers along the advancement direction of the flow in order to obtain, in the respective flow, an uninterrupted sequence of missing containers in a number equal to at least one preset number.

### BRIEF DESCRIPTION OF THE DRAWINGS

Further characteristics and advantages of the disclosure will become better apparent from the description of some preferred, but not exclusive, embodiments of an apparatus for processing containers according to the disclosure, which are illustrated by way of non-limiting example in the accompanying drawings wherein:

FIGS. 1 to 3 show a respective schematic view from above of a first sequence of operation of a first embodiment of an apparatus according to the disclosure;

FIGS. 4 to 6 show a respective schematic view from above of a second sequence of operation of a first embodiment of an apparatus according to the disclosure;

FIGS. 7 to 10 show a respective schematic view from above of a third sequence of operation of a first embodiment of an apparatus according to the disclosure; and

FIGS. 11 to 13 show a respective schematic view from above of a sequence of operation of a second embodiment of an apparatus according to the disclosure.

In the embodiments illustrated, individual characteristics shown in relation to specific examples may in reality be interchanged with other, different characteristics, existing in other embodiments.

### DETAILED DESCRIPTION OF THE DRAWINGS

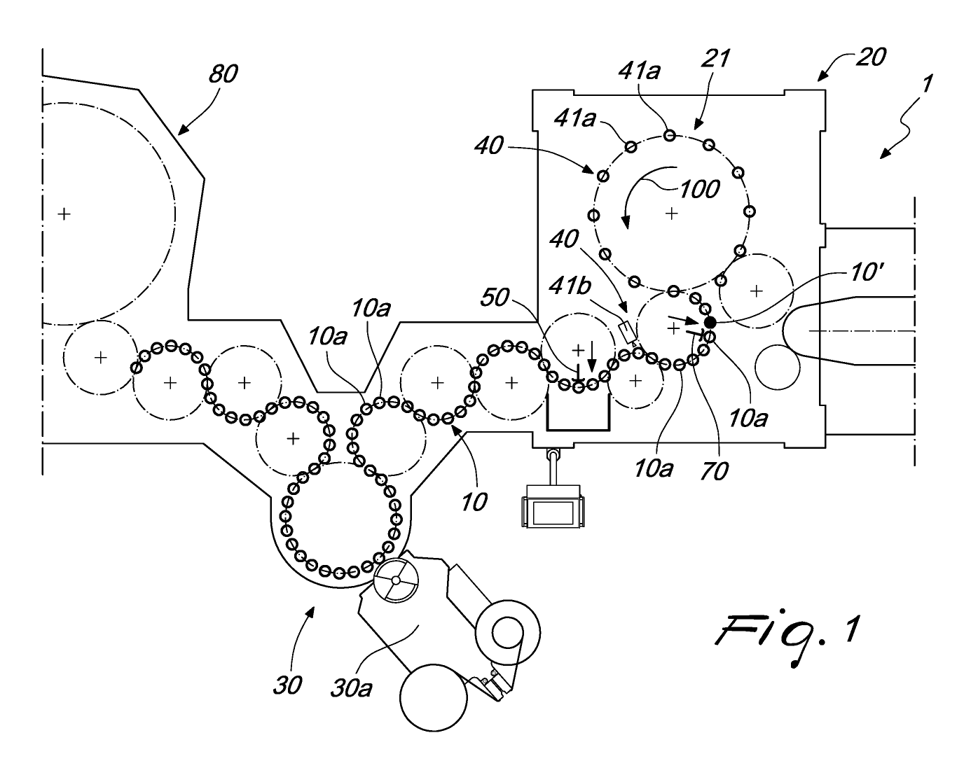

With reference to FIGS. 1-13, the present disclosure relates to an apparatus, generally designated by the reference numeral 1, for processing containers 10.

The apparatus 1 comprises at least one processing assembly 20 for the containers 10 and means for feeding a labeling unit 30 with a continuous flow of containers 10.

The labeling unit 30 comprises at least one labeling station 30a, 30b.

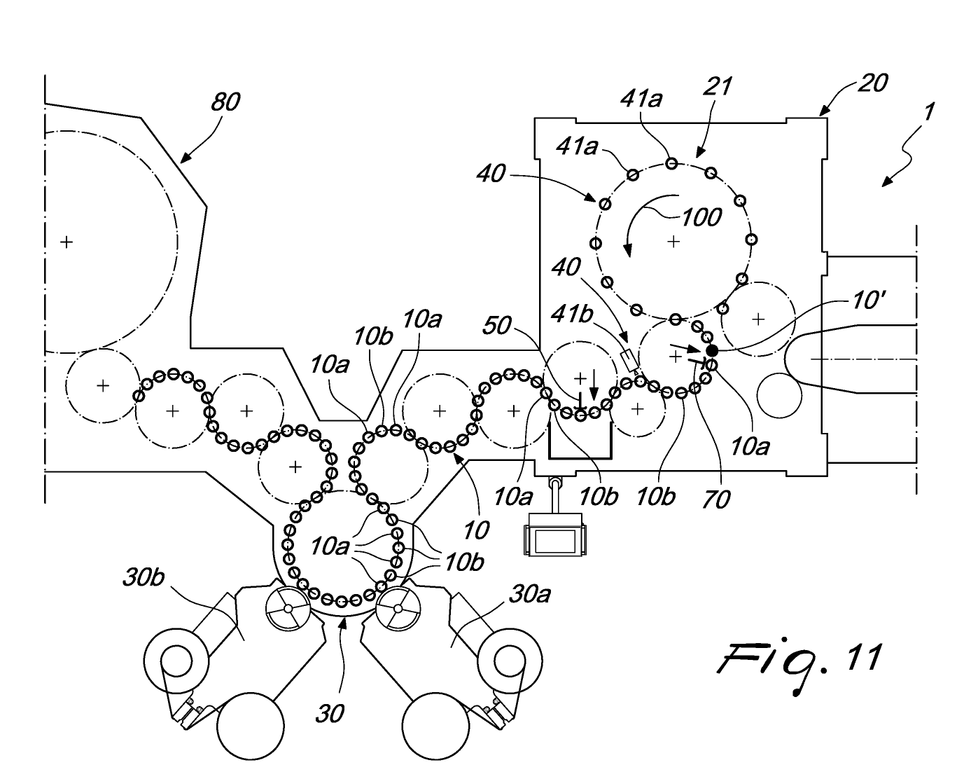

FIGS. 1 to 10 show apparatuses 1 in which the labeling unit 30 is provided with only one labeling station 30a while FIGS. 11 to 13 show an apparatus 1 in which the labeling unit 30 is provided with two labeling stations 30a, 30b.

Each labeling station 30a, 30b is intended to label the containers arriving from a respective flow of containers 10a, 10b, etc.

In essence, if, as illustrated by FIG. 1 to FIG. 10, the labeling unit 30 has only one labeling station 30a, then the respective flow of containers 10a corresponds to the continuous flow of containers fed to the labeling unit 30 while, if the labeling unit 30 is provided with two (or more) labeling stations 30a, 30b, then the respective flows of containers 10a, 10b (and optionally 10c, etc.) are mutually alternated.

According to the present disclosure, the apparatus 1 comprises means 40 for identifying non-conforming containers 10′ destined to be ejected from the flow of containers 10.

According to the disclosure there are also expulsion means 50, which are adapted to remove, from the respective flow 10a, 10b intended for a respective labeling station 30a, 30b, the containers 10 that immediately follow the positions of the non-conforming containers 10′ in the direction of advancement 100 of the flow.

The expulsion means 50 are arranged upstream of the labeling unit 30.

In this manner the expulsion means 50 can remove, from the respective flow 10a, 10b intended for a respective labeling station 30a, 30b, the containers 10 that immediately follow the positions of the non-conforming containers 10′ in the direction of advancement 100 of the flow.

In this manner, in the respective flow 10a, 10b, an uninterrupted sequence 60 is obtained of missing containers 10 in a number equal to at least one preset number.

Advantageously, the expulsion means 50 are adapted to also expel the containers 10 interposed between the last missing container 60a of the containers 10 of the uninterrupted sequence 60 and the position 60b of the successive non-conforming container (identified by the identification means 40) if the interposed containers 10 are fewer in number than the preset number.

Effectively, the proposed solution avoids carrying out the labeling process in the presence of holes or single or isolated missing containers 10.

Preferably, the processing assembly 20 for the containers 10 comprises a blower 21.

Conveniently, the labeling unit 30 is arranged immediately downstream of the blower 21.

According to a possible embodiment, the identification means 40 comprise detection means, which can be associated functionally with the container processing assembly 20 in order to detect any non-conforming containers 10′.

For example, such detection means are associated functionally with the blower 21 in order to identify the non-conforming containers 10′.

Conveniently, the detection means can be functionally connected to at least one device 70 for ejecting, from the respective flow 10a, 10b, the non-conforming containers 10′ detected by the detection means.

According to a possible embodiment shown for example in FIGS. 1 to 3 and 7 to 13, the ejection device 70 is arranged upstream of the expulsion means 50.

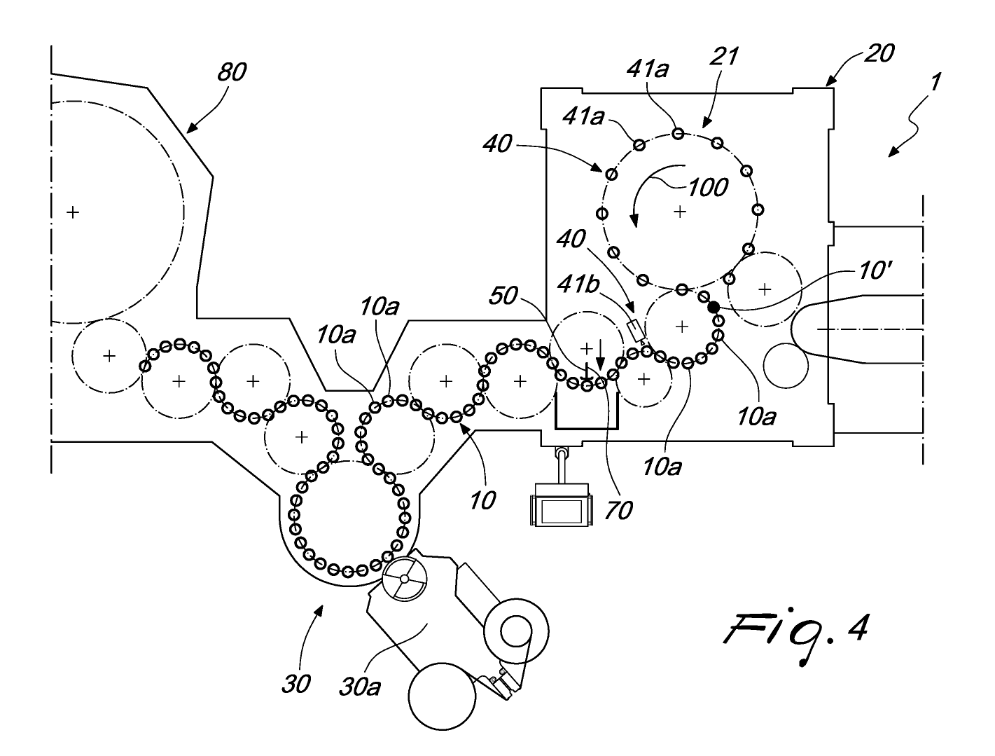

There is no reason why, as shown in the embodiment shown schematically in FIGS. 4 to 6, the ejection device 70 cannot be integrated with expulsion means 50.

In this case, the ejection of the non-conforming containers 10′ and the expulsion of the containers arranged immediately in succession along the flow is done by the expulsion means 50.

Advantageously, the expulsion means 50 are functionally associated with the detection means.

At the practical level, it is possible for the detection means to also be functionally associated with a control device that is capable of storing the position of the non-conforming containers 10′ along the respective flow of containers 10a, 10b in order to command the expulsion means 50 and/or, if envisaged, the ejection device 70.

The expulsion and/or ejection of the containers 10 from the respective flow of containers 10a, 10b will comprise the non-conforming containers 10′ detected by the detection means and optionally the conforming containers that are arranged, along the respective flow 10a, 10b, immediately in succession until an uninterrupted sequence is obtained, designated with the reference numeral 60, of missing containers 10 in a number equal to at least one preset number.

The detection means comprise first means 41a for checking the conformance of the containers 10 that are associated with the blower 21.

By way of example, the first means for checking 41a can be constituted by devices for checking the seal of the blown containers that are arranged at molds defined on the blower 21.

The detection means comprise, further, second means 41b for checking the conformance of the containers exiting from the blower.

For example, the second means 41b for checking can comprise devices for checking the shape and external conformance of the containers, by way of example, exiting from the blower 21.

Within the detection means, and in particular between the second means 41b for checking and the expulsion means 50, there are, along the respective flow of containers 10a, 10b, a number of positions for the containers 10 which is at least equal to the preset number.

In this manner in fact it is possible to command the expulsion means 50 to also expel the containers 10 interposed between the last missing container 60a of the containers 10 of the uninterrupted sequence 60 and the position 60b of the successive non-conforming container if the interposed containers are fewer in number than the preset number.

According to a possible variation of embodiment, it is possible for the expulsion means 50 to be functionally associated with an additional device for verifying the respective flow 10a, 10b arriving at each labeling station 30a, 30b.

Such additional verification device is adapted to detect any missing containers 10 along the respective flow 10a, 10b, the fact that they are missing being determined by ejection, upstream of the verification device, by the ejection device 70.

The labeling unit 30 is obviously associated with actuation means, not shown, which are adapted to interrupt labeling by the respective labeling stations 30a, 30b if containers 10 are missing along the respective flow of containers 10a, 10b.

It is possible to have, arranged downstream of the labeling unit 30 in the direction of advancement 100 of the flow, for example a filling machine 80.

Method of operation of the apparatus 1 according to the present disclosure is evident from the foregoing description.

With reference to the sequence of operation shown in FIGS. 1 to 3, the identification means 40 (which are constituted for example by the detection means) identify a non-conforming container 10′ (FIG. 1).

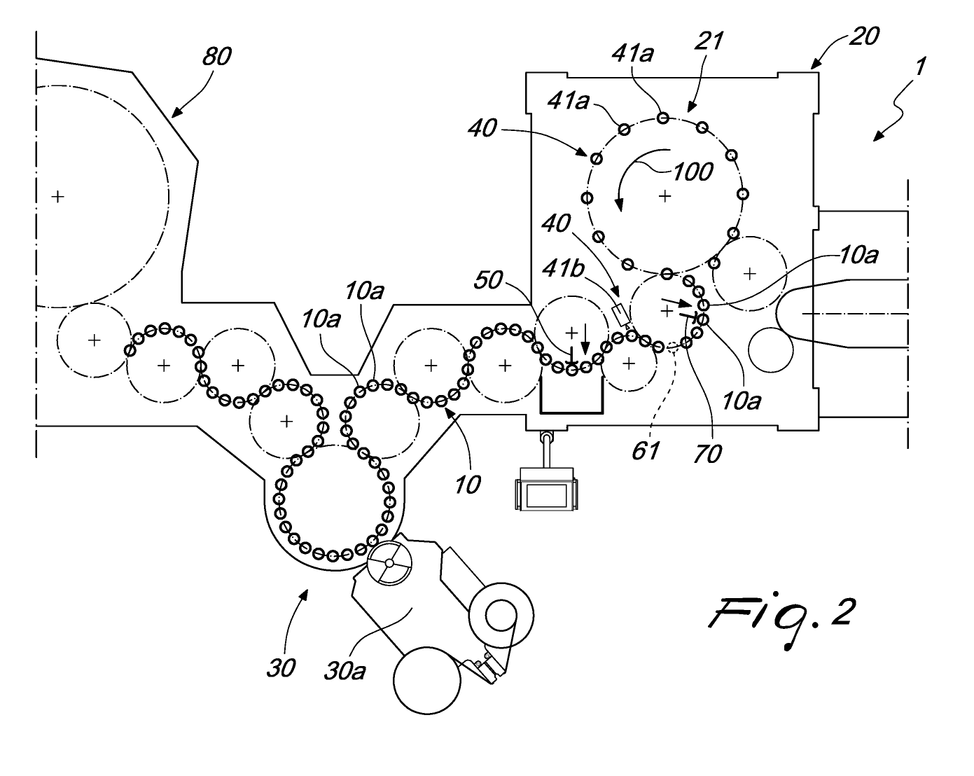

The non-conforming container 10′ is ejected from the respective flow 10a by the ejection device 70, thus producing a gap 61 (FIG. 2).

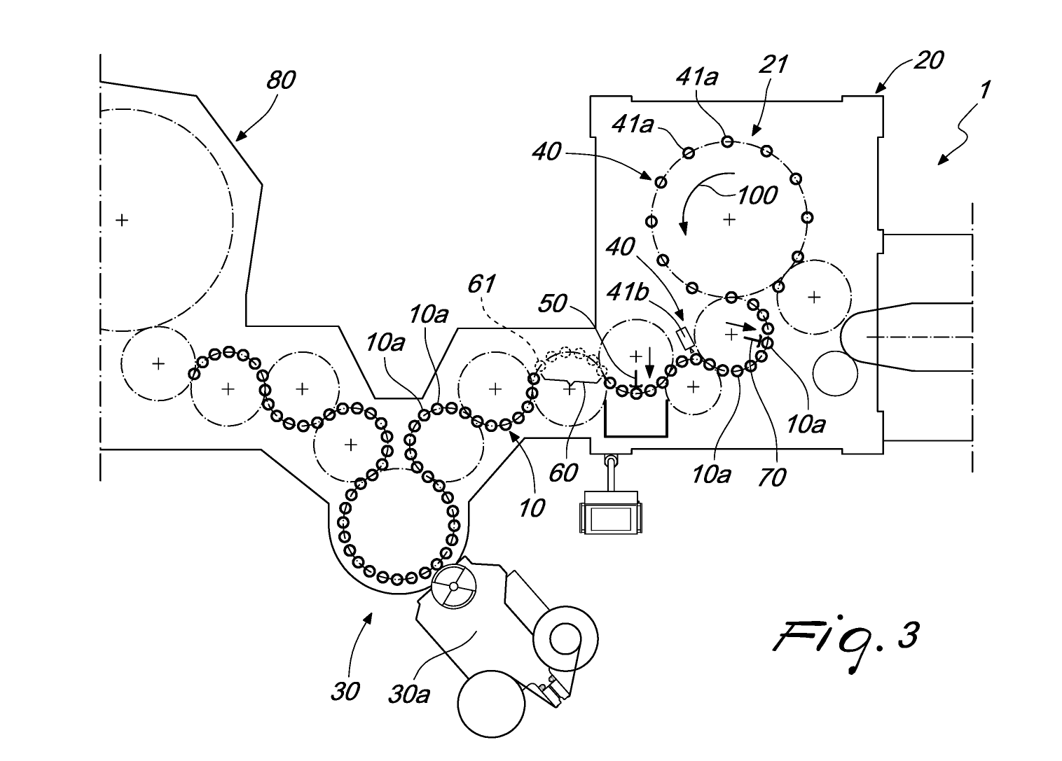

When the gap 61 arrives at the expulsion means 50, such means expel the immediately successive containers from the flow in the direction of advancement 100 of the flow in order to obtain an uninterrupted sequence 60 of missing containers in a number equal to at least one preset number (FIG. 3).

With reference to the sequence of operation shown in FIGS. 4 to 6, the identification means 40 (which are constituted for example by the detection means) identify a non-conforming container 10′ (FIG. 4).

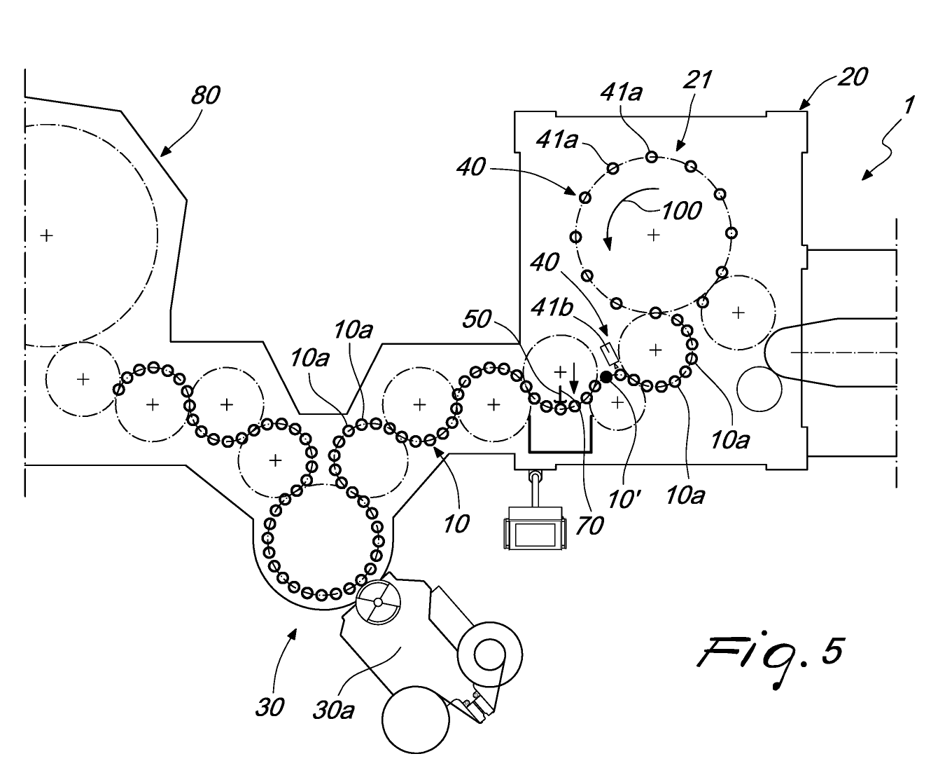

Such container advances along the respective flow 10a (FIG. 5).

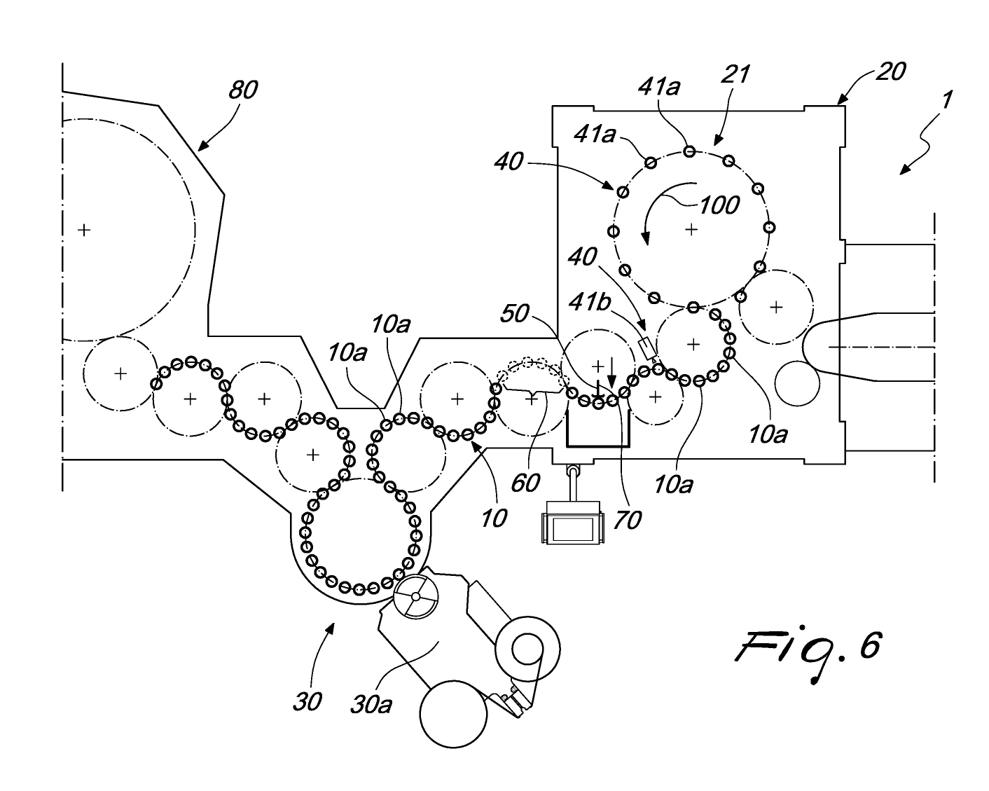

When the container 10′ arrives at the expulsion means 50, such means expel it from the flow and also expel the immediately successive containers in the direction of advancement 100 of the flow 10a in order to obtain an uninterrupted sequence 60 of missing containers in a number equal to at least one preset number (FIG. 6).

In this solution the expulsion means 50 also perform the function of the ejection device 70.

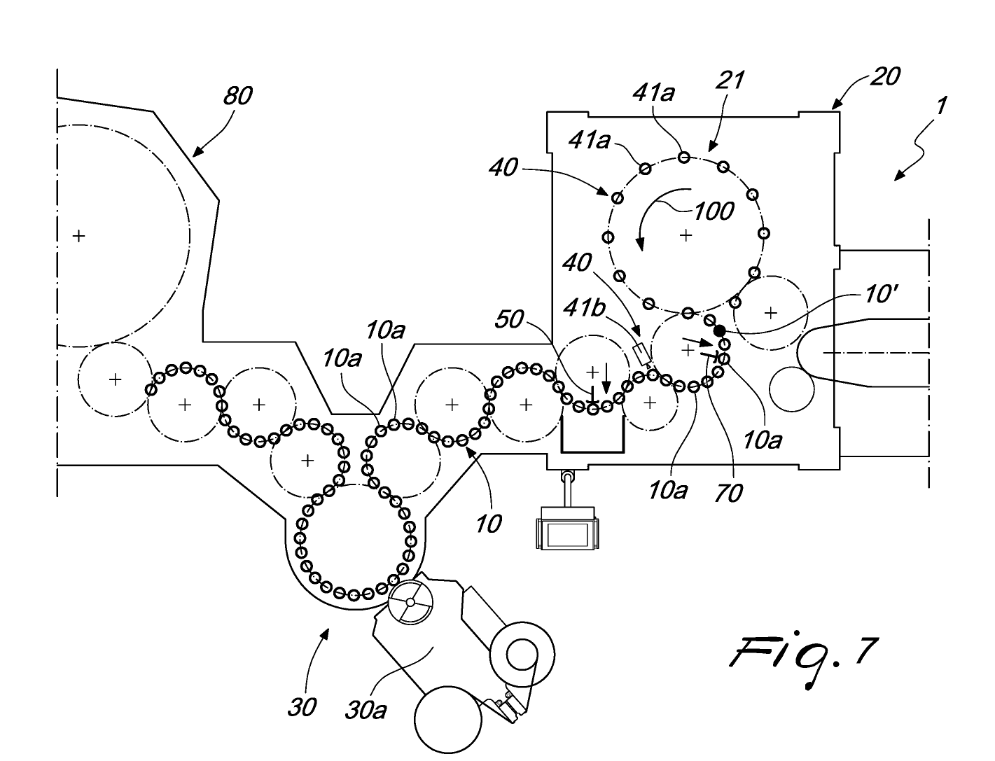

With reference to the sequence of operation shown in FIGS. 7 to 10, the identification means 40 (which are constituted for example by the detection means) identify a first non-conforming container 10′ (FIG. 7).

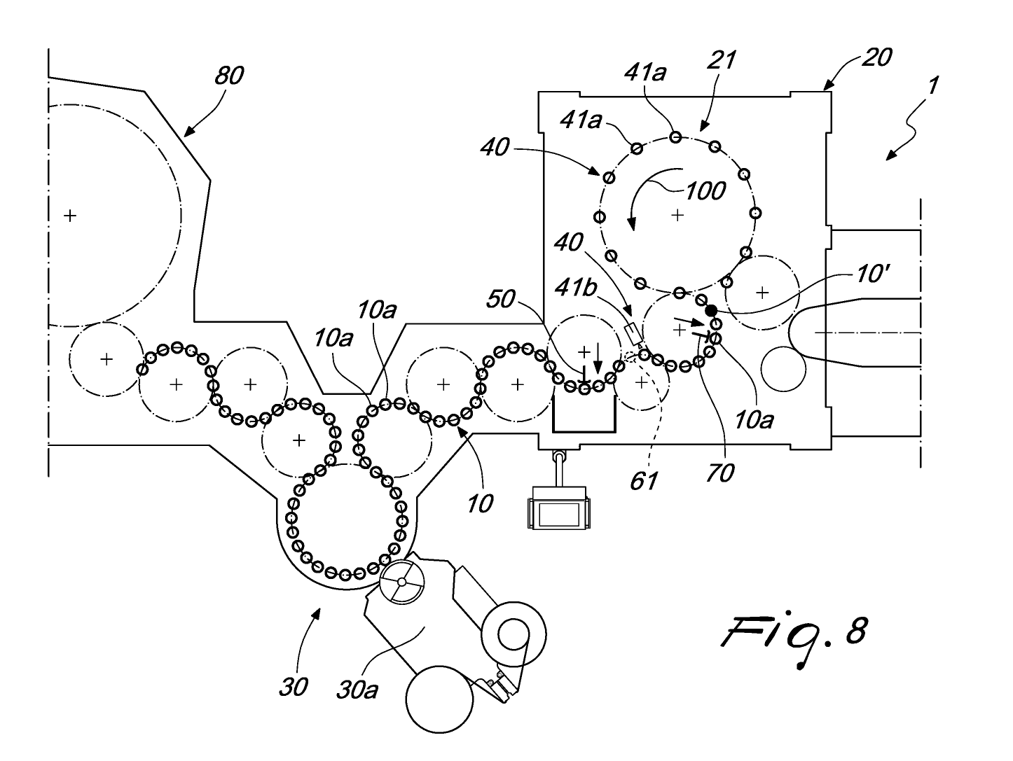

The non-conforming container 10′ is ejected from the respective flow 10a by the ejection device 70, thus producing a missing container 61 (FIG. 8).

In the meantime, the identification means 40 detect a further non-conforming container 10′ (FIG. 8).

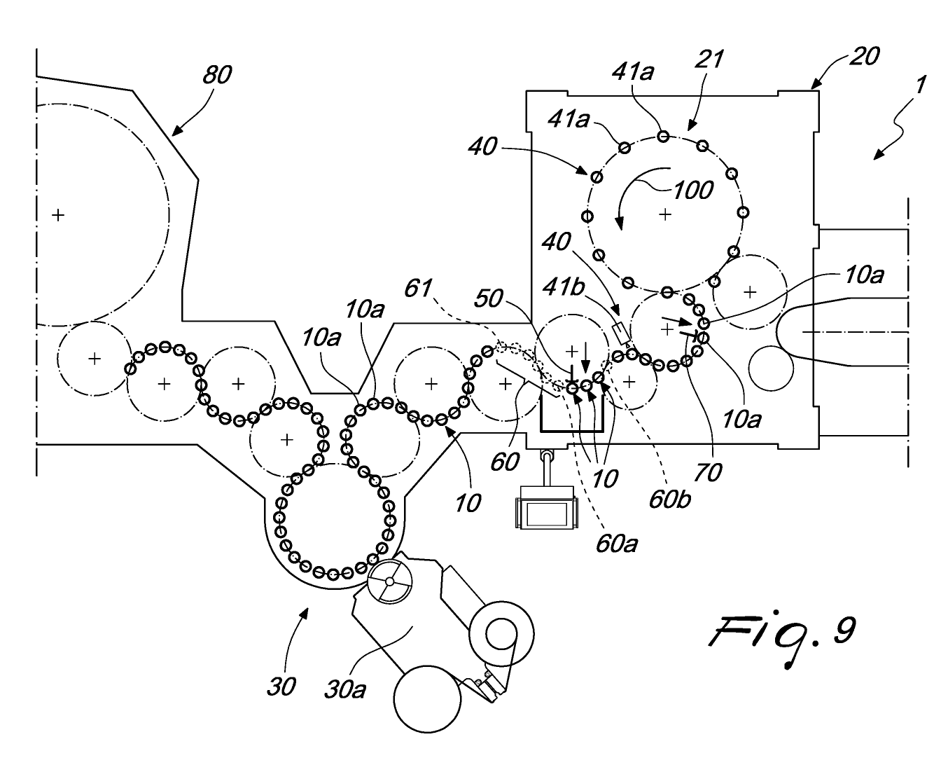

When the missing container 61 arrives at the expulsion means 50, the means of expulsion 50 expel the immediately successive containers from the flow in the direction of advancement 100 of the flow in order to obtain an uninterrupted sequence 60 of missing containers in a number equal to at least one preset number and the ejection device 70 discards the further non-conforming container 10′ thus creating a further missing container 60b (FIG. 9).

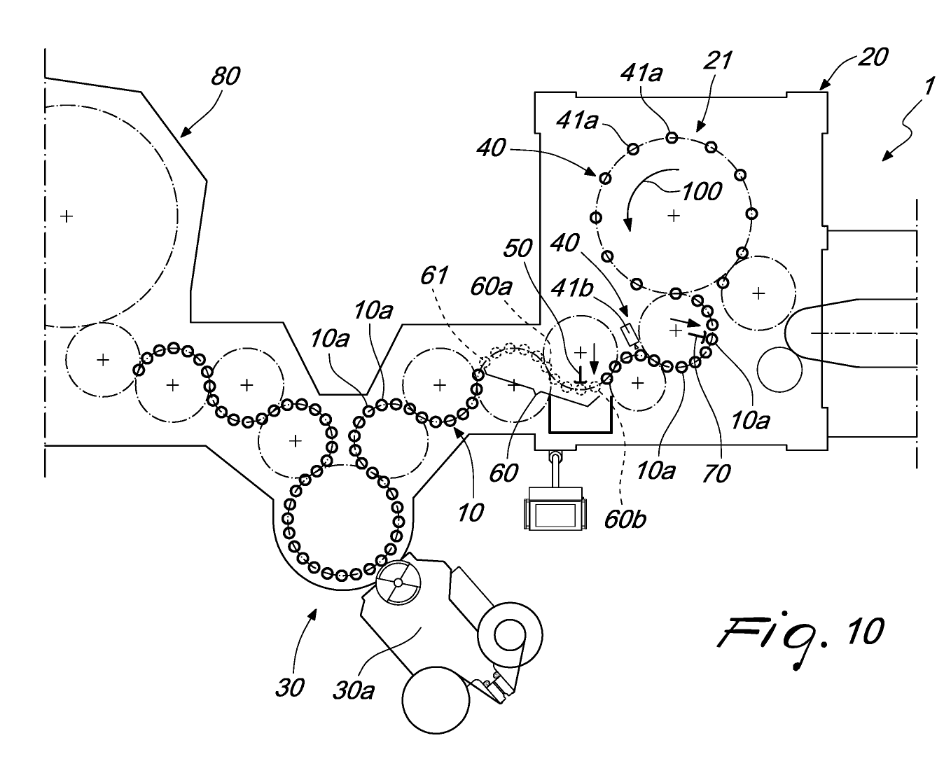

If, interposed between the last missing container 60a of the uninterrupted sequence 60 and the further missing container 60b, there is a number of containers 10 which is lower than the preset number, then the expulsion means 50 will also expel all the interposed containers 10 between the last missing container 60a and such further missing container 60b (FIG. 10).

Otherwise, the immediately successive containers after the further missing container 60b in the direction of advancement 100 of the flow will optionally be expelled, in order to obtain an uninterrupted sequence 60 of missing containers in a number equal to at least one preset number.

With reference to the sequence of operation shown in FIGS. 11 to 13, the identification means 40 (which are constituted for example by the detection means) identify a non-conforming container 10′ (FIG. 11).

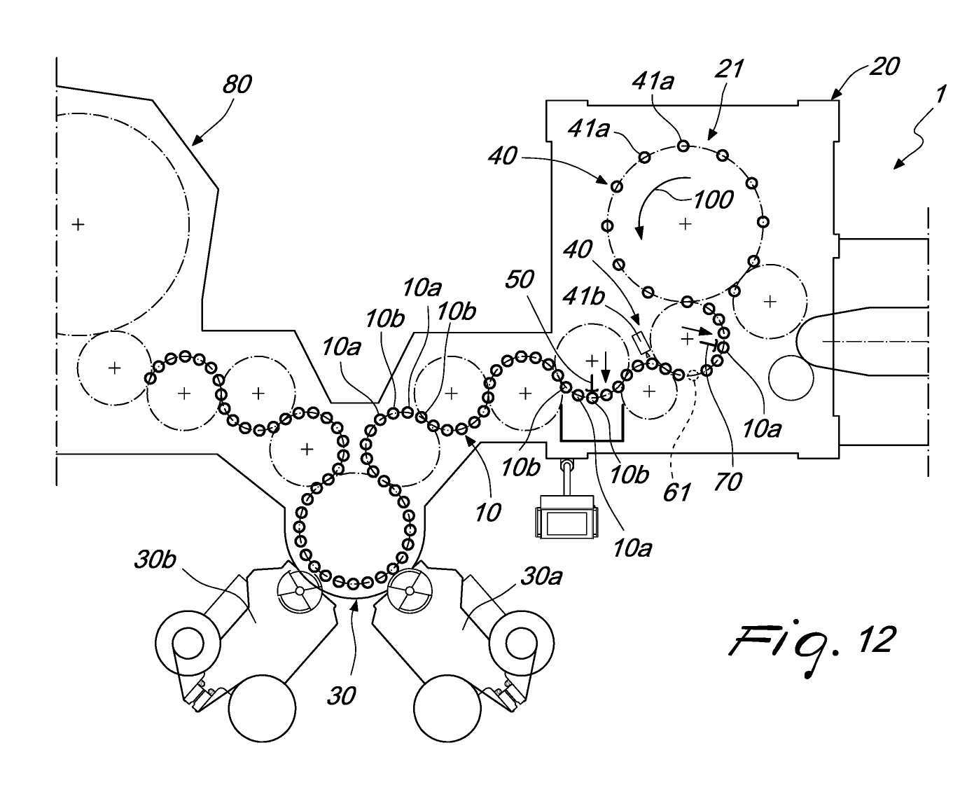

The non-conforming container 10′ is ejected from the respective flow 10a by the ejection device 70, thus producing a gap 61 (FIG. 12).

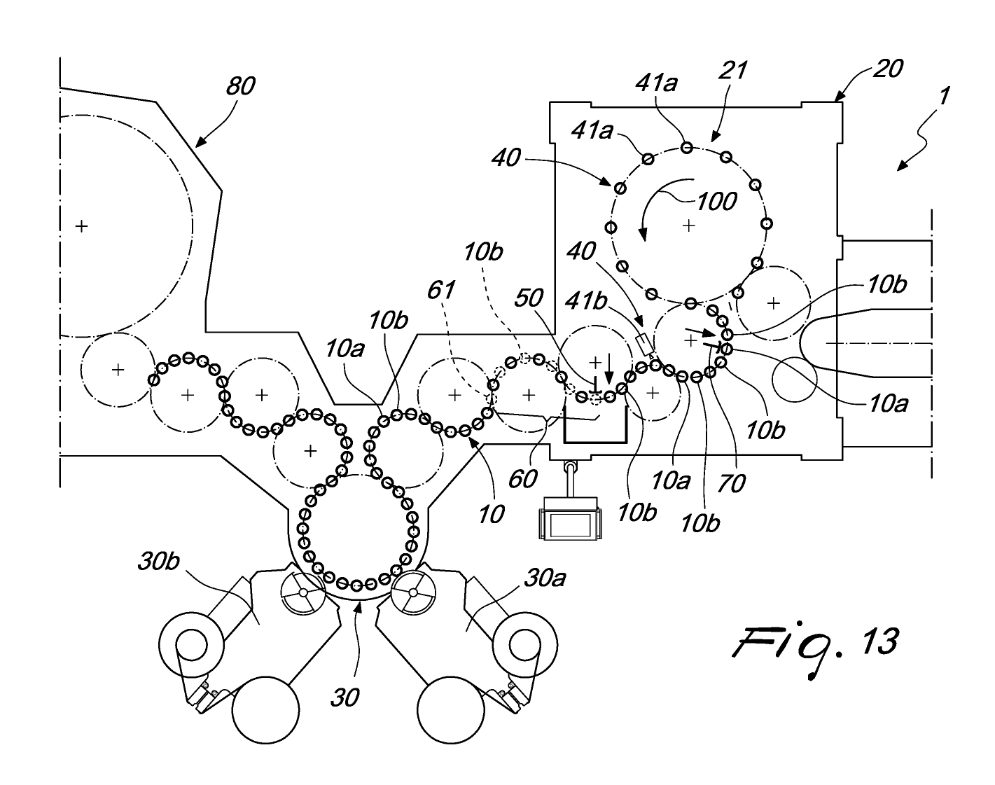

In this case, since the labeling unit 30 has two labeling stations 30a, 30b, when the gap 61 arrives at the expulsion means 50, such means expel the immediately successive containers 10 from the flow affected, specifically the flow 10b (which is constituted by an alternation of containers), in the direction of advancement 100 of the flow in order to obtain an uninterrupted sequence 60 of missing containers in a number equal to at least one preset number (FIG. 13).

Also with regard to the solutions that involve two or more labeling stations 30a, 30b, etc. which are supplied by respective flows of containers 10a, 10b, etc., similarly to what is shown in FIGS. 4 to 6, the ejection means 70 can be integrated with the expulsion means 50 and/or, as shown in FIGS. 7 to 10, if, interposed between the last missing container 60a of the uninterrupted sequence 60 and such further missing container 60b, there is a number of containers 10 which is lower than the preset number, then the expulsion means 50 will also expel all the interposed containers 10 between the last missing container 60a and such further missing container 60b.

In practice it has been found that in all the embodiments, the disclosure is capable of fully achieving the set advantages and features.

The disclosure, thus conceived, is susceptible of numerous modifications and variations.

In practice the materials employed, provided they are compatible with the specific use, and the dimensions and shapes, may be any according to requirements.

Moreover, all the details may be substituted by other, technically equivalent elements.

The disclosures in Italian Patent Application No. 102015000032730 (UB2015A002094) from which this application claims priority are incorporated herein by reference.

1.-12. (canceled)

13. An apparatus for processing containers, which comprises at least one processing assembly for containers and means for feeding, with a continuous flow, said containers to a labeling unit comprising at least one labeling station configured to label the containers that arrive from a respective flow of containers, further comprising identification means for identifying non-conforming containers which are configured to be ejected from the respective flow of containers, expulsion means being provided which are adapted to remove, from the respective flow intended for a respective labeling station, the containers that immediately follow the positions of the non-conforming containers along the advancement direction of the flow in order to obtain, in the respective flow, an uninterrupted sequence of missing containers in a number equal to at least one preset number.

14. The apparatus for processing containers according to claim 13, wherein said expulsion means are configured to expel the containers interposed between the last missing container of said uninterrupted sequence and the position of the successive non-conforming container if said interposed containers are fewer in number than said preset number.

15. The apparatus for processing containers according to claim 13, wherein said processing assembly comprises a blower.

16. The apparatus for processing containers according to claim 15, wherein said labeling unit is arranged immediately downstream of said blower.

17. The apparatus for processing containers according to claim 15, wherein said identification means comprise detection means associated functionally with said processing assembly for non-conforming containers.

18. The apparatus for processing containers according to claim 17, wherein said detection means are functionally connected to at least one ejection device for ejecting, from the respective flow of containers, the non-conforming containers detected by said detection means.

19. The apparatus for processing containers according to claim 18, wherein said at least one ejection device is arranged upstream of said expulsion means.

20. The apparatus for processing containers according to claim 18, wherein said at least one ejection device is integrated with said expulsion means.

21. The apparatus for processing containers according to claim 13, wherein between said identification means and said expulsion means there is, along the respective flow of containers, a number of positions for said containers that is at least equal to said preset number.

22. The apparatus for processing containers according to claim 17, wherein said detection means comprise first means for checking the conformance of said containers, which are associated with each mold of said blower.

23. The apparatus for processing containers according to claim 22, wherein said detection means comprise second means for checking the conformance of the containers exiting said blower.

24. The apparatus for processing containers according to claim 13, wherein said expulsion means are arranged upstream of said labeling unit.
